(19) United States
(12) Patent Application Publication
(10) Pub. No.: US 2026/0329287 A1
(43) Pub. Date: Oct. 22, 2026

(54) METHOD AND APPARATUS FOR CONTROLLING DRIVING OF MOBILITY EQUIPPED WITH STEERING ECCENTRIC DRIVE WHEEL

(71) Applicants: Hyundai Motor Company, Seoul (KR); Kia Corporation, Seoul (KR)

(72) Inventors: Eun Ho Seo, Hwaseong-si (KR); Jaehyun Kim, Hwaseong-si (KR); Hyeonsik Shin, Hwaseong-si (KR); Daekeun Yoon, Hwaseong-si (KR)

(21) Appl. No.: 19/356,407

(22) Filed: Oct. 13, 2025

(30) Foreign Application Priority Data
Apr. 18, 2025 (KR) 10-2025-0050900

(51) Int. Cl. G05D 1/43; G05D 109/10

(52) U.S. Cl. CPC G05D 1/43; G05D 2109/10

(57) ABSTRACT

An embodiment provides a method for controlling a mobility, the method includes determining position error information of the mobility based on a current position and a target position of the mobility, determining a diagonal driving angle and a turning driving angle of the mobility based on the position error information, determining a steering angle corresponding to each of at least one steering eccentric drive wheel of the mobility based on the diagonal driving angle and the turning driving angle of the mobility, and controlling the mobility to move to the target position based on the steering angle corresponding to each of the at least one steering eccentric drive wheel.

### CROSS-REFERENCE TO RELATED APPLICATIONS

This application claims the benefit of and priority to Korean Patent Application No. 10-2025-0050900 filed with the Korean Intellectual Property Office on Apr. 18, 2025, the entire contents of which are incorporated herein by reference.

### TECHNICAL FIELD

The disclosure relates to a method and apparatus for controlling driving of a mobility equipped with a steering eccentric wheel.

### BACKGROUND

A mobile robot system is being utilized in various industrial and service fields along with recent advances in artificial intelligence and sensor technology.

Existing mobile robot systems are mainly based on differential drive or fixed wheel structures, and some apply special wheels such as omni-wheels or mecanum-wheels to enable movement in various directions.

However, in a case of a differential drive method, although rotation is possible by utilizing a speed difference of each wheel, there are limitations in that a turning radius is large, it is difficult to turn while stationary, and there are restrictions on precise path control.

Additionally, in a case of an omni-wheel or mecanum-wheel-based system, omnidirectional movement is possible, but due to a limitation in friction, lack of environmental adaptability, and mechanical complexity, it is challenging to utilize such a system in an outdoor environment or on uneven terrain.

To overcome this problem, a steering eccentric drive wheel structure that integrates steering and driving functions into a single wheel system has recently been proposed. The structure is designed such that a drive shaft is eccentrically arranged, allowing for various rotational centers to be set, and as a result, it enables more flexible driving control.

In a system that uses this type of steering eccentric drive wheel structure, it is very important to determine the driving angle (i.e., turning driving angle and diagonal driving angle) based on determining a geometrical position and a driving characteristic of the wheel.

However, the steering angle of each wheel is generated non-linearly depending on the eccentric position of the steering wheel, determining the driving angle is highly complex, and additionally, due to a lack of a systematic driving strategy that considers rotational velocity and lateral velocity corresponding to turning and diagonal driving, achieving stable driving performance in various environments is challenging. It will be appreciated the term “consider” and its variants refer to taking data and/or context into account when making a determination, calculation/computation, deciding on an action, etc.

Accordingly, it is desirable to develop a technology capable of improving control for a mobility equipped with a steering eccentric drive wheel based on a driving control logic that comprehensively considers diagonal driving and turning driving.

### SUMMARY

The present disclosure attempts to provide a mobility driving control method capable of ensuring stable driving performance by setting a steering limitation range for mobility with a different steering range depending on an eccentric position, defining diagonal and turning driving angles according to a steering model, and determining a steering angle of each wheel included in the mobility.

Technical results desired to be achieved in the present disclosure are not limited to the aforementioned embodiments, and other technical results not described above will be apparent to those skilled in the art from the disclosure of the present disclosure.

An embodiment provides a method for controlling driving of a mobility equipped with a steering eccentric drive wheel, including determining position error information of the mobility based on, or otherwise by referring to, a current position and a target position of the mobility, determining a diagonal driving angle and a turning driving angle of the mobility based on the position error information, determining a steering angle corresponding to each of at least one steering eccentric drive wheel included in the mobility based on the diagonal driving angle and the turning driving angle of the mobility, and controlling driving of the mobility to move to the target position by referring to the steering angle corresponding to each of the at least one steering eccentric drive wheel.

The determining of the position error information of the mobility may include determining a rotational angle error, a lateral position error, and a longitudinal position error of the mobility based on the current position and the target position using an error model.

The determining of the diagonal driving angle and the turning driving angle of the mobility may include determining a first driving ratio based on static importance corresponding to diagonal driving and turning driving of the mobility from the position error information, determining a second driving ratio based on dynamic importance corresponding to diagonal driving and turning driving of the mobility by referring to initial driving information of the mobility determined according to the first driving ratio, and determining a diagonal driving angle and a turning driving angle of the mobility by referring to the second driving ratio.

The determining of the first driving ratio based on the static importance may include determining a first diagonal driving ratio and a first turning driving ratio of the mobility based on a ratio between a rotational angle error and a lateral position error of the mobility.

The determining of the second driving ratio based on the dynamic importance may include determining a second diagonal driving ratio and a second turning driving ratio of the mobility based on a ratio of lateral acceleration and centripetal acceleration of the mobility.

The second diagonal driving ratio and the second turning driving ratio may be determined based on determining a ratio of a maximum driving velocity and an initial driving velocity of the above mobility.

The determining of the diagonal driving angle and the turning driving angle of the mobility by referring to the second driving ratio may include determining the diagonal driving angle of the mobility by using a maximum lateral velocity determined based on a lateral error of the mobility and the second diagonal driving ratio, and determining the turning driving angle by using a maximum rotational velocity determined based on a rotational angle error of the mobility and the second turning driving ratio.

The determining of the steering angle corresponding to each of the at least one steering eccentric drive wheel may include determining a first wheel having a minimum steering drive range by referring to an eccentric position corresponding to each of the at least one steering eccentric drive wheel.

The determining of the steering angle corresponding to each of the at least one steering eccentric drive wheel may include determining a model turning angle corresponding to a steering model of the mobility based on the turning angle within a range of a maximum steering angle of the first wheel, and determining a model diagonal driving angle corresponding to the steering model based on the diagonal driving angle within an angle range excluding the model turning driving angle in the maximum steering angle of the first wheel.

The determining of the steering angle corresponding to each of the at least one steering eccentric drive wheel may include determining a steering angle corresponding to each of the at least one steering eccentric drive wheel by referring to the model turning driving angle and the model diagonal driving angle.

Another embodiment provides an apparatus corresponding to controlling driving of a mobility equipped with a steering eccentric drive wheel, including a memory configured to store a mobility driving control program, and a processor configured to load the mobility driving control program from the memory to execute the mobility driving control program, and the processor may be configured to determine position error information of the mobility by referring to a current position and a target position of the mobility to determine a diagonal driving angle and a turning driving angle of the mobility based on the position error information, to determine a steering angle corresponding to each of at least one steering eccentric drive wheel included in the mobility based on the diagonal driving angle and the turning driving angle of the mobility, and to control driving of the mobility to move to the target position by referring to the steering angle corresponding to each of the at least one steering eccentric drive wheel.

The processor may be configured to determine a rotational angle error, a lateral position error, and a longitudinal position error of the mobility based on the current position and the target position using an error model.

The processor may be configured to determine a first driving ratio based on static importance corresponding to diagonal driving and turning driving of the mobility from the position error information, to determine a second driving ratio based on dynamic importance corresponding to diagonal driving and turning driving of the mobility by referring to initial driving information of the mobility determined according to the first driving ratio, and determine a diagonal driving angle and a turning driving angle of the mobility by referring to the second driving ratio.

The processor may be configured to determine a first diagonal driving ratio and a first turning driving ratio of the mobility based on a ratio between a rotational angle error and a lateral position error of the mobility.

The processor may be configured to determine a second diagonal driving ratio and a second turning driving ratio of the mobility based on a ratio of lateral acceleration and centripetal acceleration of the mobility.

The processor may be configured to determine the diagonal driving angle of the mobility by using a maximum lateral velocity determined based on a lateral error of the mobility and the second diagonal driving ratio, and to determine the turning driving angle by using a maximum rotational velocity determined based on a rotational angle error of the mobility and the second turning driving ratio.

The processor may be configured to determine a first wheel having a minimum steering drive range by referring to an eccentric position corresponding to each of the at least one steering eccentric drive wheel.

The processor may be configured to determine a model turning angle corresponding to a steering model of the mobility based on the turning angle within a range of a maximum steering angle of the first wheel, and to determine a model diagonal driving angle corresponding to the steering model based on the diagonal driving angle within an angle range excluding the model turning driving angle in the maximum steering angle of the first wheel.

The processor may be configured to determine a steering angle corresponding to each of the at least one steering eccentric drive wheel by referring to the model turning driving angle and the model diagonal driving angle.

Another embodiment provides a computer program stored on a computer-readable recording medium, the computer program, when executed by a processor, has instructions corresponding to causing the processor to perform a mobility driving control method, including determining position error information of the mobility by referring to a current position and a target position of the mobility, determining a diagonal driving angle and a turning driving angle of the mobility based on the position error information, determining a steering angle corresponding to each of at least one steering eccentric drive wheel included in the mobility based on the diagonal driving angle and the turning driving angle of the mobility, and controlling driving of the mobility to move to the target position by referring to the steering angle corresponding to each of the at least one steering eccentric drive wheel.

According to an embodiment, by determining the ratios of the turning driving and the diagonal driving while considering static error factors (i.e., position error), dynamic error factors (i.e., acceleration error), and the kinematic elements of the mobility, it may be possible to improve control in the process of the mobility reaching the target position.

In addition, according, a steering angle limitation in the steering model may be determined based on the maximum steering angle of the wheel having the minimum steering range, so it may be possible to perform computationally efficient driving control corresponding to mobility compared to independently limiting the steering range corresponding to each of at least one steering eccentric drive wheel.

### BRIEF DESCRIPTION OF THE DRAWINGS

FIG. 1 illustrates a block diagram showing a mobility driving control apparatus according to an embodiment.

FIG. 2 illustrates a conceptual block diagram showing a function of a mobility driving control program according to an embodiment.

FIG. 3 illustrates a flowchart showing a method for controlling the driving of a mobility including a steering eccentric drive wheel according to an embodiment.

FIG. 4 illustrates an example of determination of position error information according to an embodiment.

FIGS. 5A and 5B illustrates an example of determination of a maximum steering angle of a steering model by referring to an eccentric position of a steering eccentric drive wheel included in a mobility according to an embodiment.

FIG. 6 illustrates an example of determination of a first driving ratio and a second driving ratio according to an embodiment.

FIGS. 7A, 7B and 7C illustrates an example of driving control of a mobility by referring to a model diagonal driving angle and a model turning driving angle according to an embodiment.

### DETAILED DESCRIPTION OF ILLUSTRATIVE EMBODIMENTS

The advantages and features of the present disclosure and the methods for accomplishing the same will be apparent from the embodiments described hereinafter with reference to the accompanying drawings. However, the present disclosure is not limited to the embodiments and may be embodied in various other forms or examples. These embodiments are provided so that this disclosure will be thorough and complete, and will fully convey the scope of the present disclosure to those skilled in the art. The scope of the present disclosure is defined in the appended claims.

In the following description of embodiments of the present disclosure, when a detailed description of known configurations or functions may obscure the subject matter of the present disclosure, a detailed description thereof will be omitted. Then, the terms described below are terms defined in consideration of functions in embodiments of the present disclosure, and may vary depending on the intention or custom of a user or operator. Accordingly, the definition should be based on the contents throughout this specification.

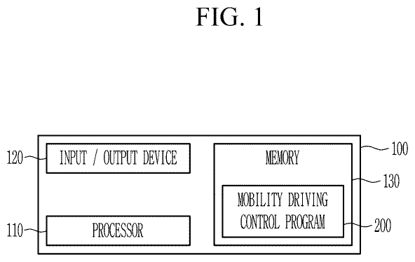

FIG. 1 illustrates a block diagram showing a mobility driving control apparatus according to an embodiment.

Referring to FIG. 1, the mobility driving control apparatus 100 may include a processor 110, an input/output device 120, and a memory 130.

The controller 110 may generally control an operation of the mobility driving control apparatus 100.

The processor 110 may receive position information including coordinates corresponding to a current position of a mobility and coordinates corresponding to a target position (or target point) using the input/output device 120.

Additionally, the processor no may receive driving information including a current velocity and acceleration of the mobility using the input/output device 120.

In this specification, for better understanding and ease of description, at least one of position information and driving information is described as being input through input/output device 120, but the present disclosure is not limited thereto. That is, according to an embodiment, the mobility driving control apparatus 100 may include a transceiver (or a transmitter and receiver) (not shown), and the mobility driving control apparatus 100 may receive at least one of position information or driving information using the transceiver (or a transmitter and receiver) (not shown), and at least one of the position information or the driving information may be collected or generated within the mobility driving control apparatus 100.

The processor no may determine a diagonal driving angle and a turning driving angle of the mobility based on the position error information determined by referring to the current position and target position of the mobility, and may control driving of the mobility by referring to a steering angle corresponding to each of at least one steering eccentric wheel included in the mobility determined based on the diagonal driving angle and the turning driving angle of the mobility.

The input/output device 120 may include one or more input devices and/or one or more output devices. For example, the input devices may include a microphone, a keyboard, a mouse, a touch screen, etc., and the output devices may include a display, speaker, etc.

The memory 130 may store a mobility driving control program 200 and information desirable for executing the mobility driving control program 200.

In this specification, the mobility driving control program 200 may indicate software including commands for determining a diagonal driving angle and a turning driving angle of the mobility based on the position error information determined by referring to the current position and the target position of the mobility and controlling driving of the mobility by referring to a steering angle corresponding to each of at least one steering eccentric wheel included in the mobility determined based on the diagonal driving angle and the turning driving angle of the mobility.

The processor no may load the mobility driving control program 200 and information desirable for executing the mobility driving control program 200 from the memory 130 to execute the mobility driving control program 200.

The processor 110 may determine position error information of the mobility by referring to the current position and the target position of the mobility, determine a diagonal driving angle and a turning driving angle of the mobility based on the position error information, determine a steering angle corresponding to each of at least one steering eccentric drive wheel included in the mobility based on the diagonal driving angle and the turning driving angle of the mobility, and control the driving of the mobility to move to the target position by referring to the steering angle corresponding to each of at least one steering eccentric wheel.

In an embodiment, the mobility including a steering eccentric drive wheel may indicate an autonomous driving robot capable of freely driving diagonally and turning as it has an eccentric structure in which a driving shaft is positioned away from a center of the wheel.

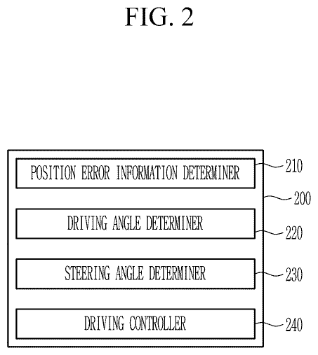

Functions and/or operations of the mobility driving control program 200 will be described in detail with reference to FIG. 2.

FIG. 2 illustrates a conceptual block diagram showing a function of a mobility driving control program according to an embodiment.

Referring to FIG. 2, the mobility driving control program 200 may include a position error information determiner 210, a driving angle determiner 220, a steering angle determiner 230, and a driving controller 240.

The position error information determiner 210, the driving angle determiner 220, the steering angle determiner 230, and the driving controller 240 illustrated in FIG. 2 may be elements which are conceptually divided according to the functions of the mobility driving control program 200 to easily describe the functions of the mobility driving control program 200, and the present disclosure is not limited thereto. According to embodiments, the functions of the position error information determiner 210, the driving angle determiner 220, the steering angle determiner 230, and the driving controller 240 may be merged or separated, and may be implemented as a series of instructions included in a single program.

First, the position error information determiner 210 may determine position error information of the mobility by referring to the current position and the target position of the mobility.

The position error information according to an embodiment may indicate a difference in direction and distance between the current position and the target position based on the center of the mobility, and may include, e.g., a lateral error, a longitudinal error, and a rotational angle error.

Specifically, the position error information determiner 210 may determine the rotational angle error, the lateral position error, and the longitudinal position error of the mobility from the current position and the target position using an error model.

Herein, the error model may indicate a model for determining, e.g., calculating or otherwise obtaining, a driving error based on the difference between a target driving state of the mobility (target position, target velocity, target acceleration, target attitude, etc.) and a current driving state (current position, current velocity, current acceleration, current attitude, etc.).

Next, the driving angle determiner 220 may determine the diagonal driving angle and the turning driving angle of the mobility based on the position error information.

Herein, the diagonal driving angle may refer to an angle corresponding to diagonal driving based on a center of the mobility.

Additionally, the turning angle may refer to an angle corresponding to rotating (or turning) based on the center of the mobility.

Specifically, the driving angle determiner 220 may determine a driving ratio corresponding to diagonal driving and turning driving of the mobility.

The driving ratio according to an embodiment may indicate a ratio between diagonal driving and turning driving determined for moving to the target position, and may include, e.g., a first driving ratio determined based on statically determined position information and a second driving ratio determined based on dynamically determined driving information.

More specifically, the driving angle determiner 220 may determine the first driving ratio based on static importance corresponding to the diagonal driving and the turning driving of the mobility from the position error information.

For example, the driving angle determiner 220 determine a first diagonal driving ratio and a first turning driving ratio of the mobility based on the ratio between the rotational angle error and the lateral position error of the mobility.

In addition, the driving angle determiner 220 may determine a second driving ratio based on the dynamic importance corresponding to the diagonal driving and the turning driving of the mobility by referring to initial driving information of the mobility determined according to the first driving ratio.

For example, the driving angle determiner 220 may determine the second diagonal driving ratio and the second turning driving ratio of the mobility based on a ratio of the lateral acceleration and centripetal acceleration of the mobility.

Meanwhile, the first driving ratio and the second driving ratio according to an embodiment may be normalized based on a first normalization constant and a second normalization constant, respectively, and the first normalization constant may be characterized as being greater than or equal to the second normalization constant.

Specifically, the second diagonal driving ratio and the second turning driving ratio according to an embodiment may be determined based on determining the second normalization constant corresponding to a ratio between a maximum driving velocity and an initial driving velocity of the mobility.

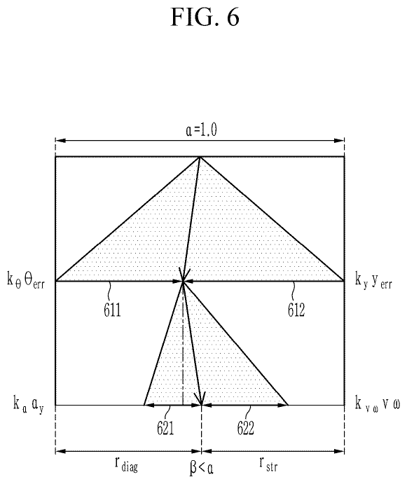

Details regarding the first driving ratio and the second driving ratio will be described later in FIG. 6.

In addition, the driving angle determiner 220 may determine the diagonal driving angle and the turning driving angle of the mobility by referring to the second driving ratio.

More specifically, the driving angle determiner 220 may determine the diagonal driving angle of the mobility by using a maximum lateral velocity determined based on the lateral error of the mobility and the second diagonal driving ratio.

For example, the driving angle determiner 220 may determine a maximum lateral velocity based on a maximum gain value corresponding to the lateral position error determined through the error model, and the maximum lateral velocity v_{y} may be expressed as shown in Equation 1.

v_{y}=r_{diag}·k_{y.max}·yₑᵣᵣ

Herein, r_{diag} may represent the second diagonal driving ratio, k_{y.max} may represent the maximum gain value corresponding to the lateral position error, which is an upper limit of a control coefficient that determines how much an error between the current position and the target position is converted into a lateral velocity, and yₑᵣᵣ may represent the lateral position error.

In addition, the driving angle determiner 220 may determine the diagonal driving angle of the mobility based on the maximum lateral velocity, considering a structural characteristic of the mobility, and the diagonal driving angle θ_{diag} may be expressed as shown in Equation 2.

θ_{diag}=kine(v_{y})

Herein, kine(⋅) may indicate a kinematic function determined based on determining the structural and geometric characteristics of the mobility.

More specifically, the driving angle determiner 220 may determine the turning driving angle of the mobility using a maximum rotational velocity, which is determined based on the rotational angle error of the mobility and the second turning driving ratio.

For example, the driving angle determiner 220 may determine a maximum rotational velocity based on the maximum gain value corresponding to the rotational angle error, which is determined through the error model, and the maximum rotational velocity ω may be expressed as shown in Equation 3.

ω=rₛₜᵣ·k_{ω.max}·θₑᵣᵣ

Herein, rₛₜᵣ may represent the second turning driving ratio, k_{ω.max} may represent the maximum gain value corresponding to the rotational angle error, which is the upper limit of the control coefficient that determines how much an error between the current posture and the target posture is converted into an angular velocity, and θₑᵣᵣ may represent the rotational angle error.

In addition, the driving angle determiner 220 may determine the turning driving angle of the mobility based on the maximum rotational velocity, considering a structural characteristic of the mobility, and the turning driving angle θₛₜᵣ may be expressed as shown in Equation 4.

θₛₜᵣ=kine(ω)

Herein, kine(⋅) may indicate a kinematic function determined based on determining the structural and geometric characteristics of the mobility.

As such, in the present disclosure, by determining the ratios of the turning driving and the diagonal driving while considering static error factors (i.e., position error), dynamic error factors (i.e., acceleration error), and the kinematic elements of the mobility, an unique effect of enabling improved control in the process of the mobility reaching the target position may be achieved.

Next, the steering angle determiner 230 may determine a steering angle corresponding to each of at least one steering eccentric drive wheel included in the mobility based on the diagonal driving angle and the turning driving angle of the mobility.

Specifically, the steering angle determiner 230 may determine a first wheel having a minimum steering drive range by referring to an eccentric position corresponding to each of the at least one steering eccentric drive wheel.

More specifically, the steering angle determiner 230 may determine a maximum steering angle of the first wheel having the minimum steering drive range among at least one steering eccentric drive wheel as a maximum steering angle of the mobility based on determining the maximum collision range (e.g., a maximum range indicating a collision between a mobility body and the wheel) determined according to the eccentric position.

This may ensure that another wheel does not go beyond the collision range based on the maximum steering angle of the mobility.

Additionally, the steering angle determiner 230 may determine a model turning angle corresponding to the steering model of the mobility based on the turning angle of the mobility within a range of the maximum steering angle of the first wheel.

Herein, the steering model of the mobility may a model that receives the turning driving angle and the diagonal driving angle of the mobility and determines a driving command corresponding to the steering angle of each wheel.

The steering model may be formed of a center wheel corresponding to determining a model diagonal driving angle and a front wheel corresponding to determining a model turning driving angle and a diagonal driving angle.

The model turning angle according to an embodiment may be determined through the front wheel of the steering model, and may indicate the turning angle of the mobility included in the range of the maximum steering angle.

Next, the steering angle determiner 230 may determine a model diagonal driving angle corresponding to the steering model from the diagonal driving angle of the mobility within an angle range excluding the model turning driving angle from the maximum steering angle of the first wheel.

The model diagonal driving angle according to an embodiment may be determined through the center wheel of the steering model, and may indicate the diagonal driving angle of the mobility included in the angle range excluding the model turning driving angle from the maximum steering angle.

Next, the steering angle determiner 230 may determine a steering angle corresponding to each of at least one steering eccentric drive wheel by referring to the model turning driving angle and the model diagonal driving angle.

In the present disclosure, among different steering ranges of at least one steering eccentric wheel, a steering angle having a minimum range may be set as the maximum steering angle of the steering model, and then a steering angle of the steering eccentric drive wheel may be determined using the steering model.

That is, a steering angle limitation in the steering model may be determined based on the maximum steering angle of the wheel having the minimum steering range, so a unique effect of enabling computationally efficient driving control corresponding to mobility may be achieved compared to independently limiting the steering range corresponding to each of at least one steering eccentric drive wheel.

Next, the driving controller 240 may control driving of the mobility to move to the target position by referring to the steering angle corresponding to each of at least one steering eccentric drive wheel.

For example, based on the model diagonal driving angle being 0, the driving controller 240 may control the turning driving of the mobility by referring to the steering angle corresponding to each of the at least one steering eccentric drive wheel determined based on the model turning driving angle. It will be appreciated in some embodiments, comparisons are not precise, and tests/determinations/computations apply, for example, to values substantially equal to 0.

For another example, based on the model turning driving angle being 0, the driving controller 240 may control the diagonal driving of the mobility by referring to the steering angle corresponding to each of the at least one steering eccentric drive wheel determined based on the model turning driving angle.

For example, based on both the model turning driving angle and the model diagonal driving angle not being 0, the driving controller 240 may control diagonal driving and turning driving of the mobility by referring to the steering angle corresponding to each of the at least one steering eccentric drive wheel determined based on the model diagonal driving angle and the model turning driving angle.

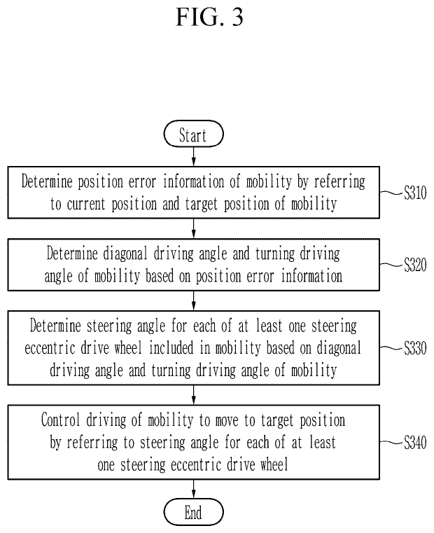

FIG. 3 illustrates a flowchart showing a method for controlling the driving of a mobility including a steering eccentric drive wheel according to an embodiment.

Referring to FIG. 3, the position error information determiner 210 may determine position error information of the mobility by referring to the current position and the target position of the mobility (S310).

Next, the driving angle determiner 220 may determine the diagonal driving angle and the turning driving angle of the mobility based on the position error information (S320).

Next, the steering angle determiner 230 may determine a steering angle corresponding to each of at least one steering eccentric drive wheel included in the mobility based on the diagonal driving angle and the turning driving angle of the mobility (S330).

Next, the driving controller 230 may control driving of the mobility to move to the target position by referring to the steering angle corresponding to each of at least one steering eccentric drive wheel (S340).

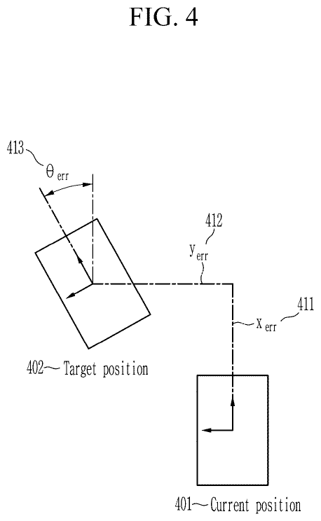

FIG. 4 illustrates an example of determination of position error information according to an embodiment.

Referring to FIG. 4, the mobility driving control apparatus 100 may determine position error information of the mobility by inputting a current position 401 and a target position 402 of the mobility into an error model.

Specifically, the mobility driving control apparatus 100 may determine a longitudinal position error xₑᵣᵣ 411, a lateral position error yₑᵣᵣ 412, and a rotational angle error θₑᵣᵣ 413 using the error model.

Through this, the present disclosure enables the mobility to generate a steering command to converge to a target position.

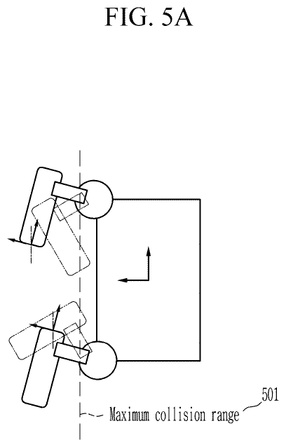

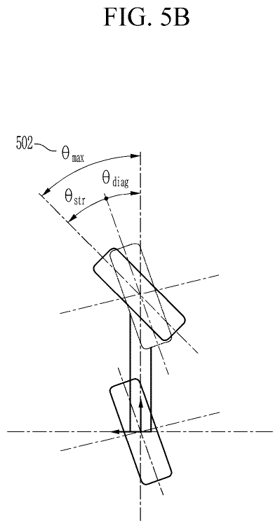

FIG. 5 illustrates an example of determination of a maximum steering angle of a steering model by referring to an eccentric position of a steering eccentric drive wheel included in a mobility according to an embodiment.

FIG. 5A illustrates a mobility body and a steering eccentric drive wheel, and FIG. 5B illustrates a steering model for a mobility.

Referring to FIG. 5A, the mobility control driving apparatus 100 may determine a first wheel having a minimum steering drive range by referring to an eccentric position corresponding to each of at least one steering eccentric drive wheel.

Specifically, the mobility driving control apparatus 100 may determine the first wheel having the minimum steering driving range by considering a maximum collision range 501 of the mobility body and each steering eccentric drive wheel.

Referring to FIG. 5B, the mobility driving control apparatus 100 may determine a maximum steering angle of the first wheel as a maximum steering angle θₘₐₓ 502 of the steering model. Within a range of the maximum steering angle 502, a model turning driving angle may be determined primarily, and a model diagonal driving angle may be determined secondarily.

Accordingly, a steering angle limitation in the steering model may be determined based on the maximum steering angle of the wheel with the minimum steering range, so a mobility body may avoid a collision with another wheel based on the maximum steering angle of the steering model.

In addition, the present disclosure may enable computationally efficient driving control for a mobility compared to independently limiting the steering range corresponding to each of at least one steering eccentric drive wheel.

FIG. 6 illustrates an example of determination of a first driving ratio and a second driving ratio according to an embodiment.

Referring to FIG. 6, the mobility driving control apparatus 100 may determine a first driving ratio based on a ratio of a rotational angle error and a lateral position error of a mobility.

A first diagonal driving ratio 611 and a first turning driving ratio 612 included in the first driving ratio according to an embodiment may be expressed as in following Equation 5.

$${r}_{diag ( 1 )} = \frac{α {k}_{y} {y}_{e r r}}{{k}_{θ} {θ}_{e r r} + {k}_{y} {y}_{e r r}}$$

$${r}_{str 1} = \frac{α {k}_{θ} {θ}_{e r r}}{{k}_{θ} {θ}_{e r r} + {k}_{y} {y}_{e r r}}$$

Herein, r_{diag(1)} may represent the first diagonal driving ratio, r_{str 1} may represent the first turning driving ratio, α may represent a first normalization constant (i.e., 1), yₑᵣᵣ may represent a lateral error, θₑᵣᵣ may represent a rotational angle error, and k_{θ} and k_{y} may represent normalization ratios of the rotational angle error and the lateral error, respectively.

Herein, as the lateral error becomes larger compared to the rotational angle error according to an embodiment, the first diagonal driving ratio 611 may become higher, so a diagonal driving angle may become larger.

In addition, as the rotational angle error is larger compared to the lateral error according to an embodiment, the first turning ratio 612 may increase, so a turning angle may increase.

Next, the driving a mobility control apparatus 100 may determine a second driving ratio of the mobility based on a ratio of lateral acceleration and centripetal acceleration of the mobility.

A second diagonal driving ratio 621 and a second turning driving ratio 622 included in the second driving ratio according to an embodiment may be expressed as in following Equation 6.

$${r}_{diag ( 2 )} = \frac{a {β}_{a} {k}_{v ω} v ω}{{k}_{a} {a}_{y} + {k}_{v ω} v ω}$$

$${r}_{str 2} = \frac{b {β}_{v w} {k}_{a} {a}_{y}}{{k}_{a} {a}_{y} + {k}_{v ω} v ω}$$

$${β}_{a} = \frac{{v}_{max} - v}{{v}_{max}}$$

$${β}_{v w} = \frac{v}{{v}_{max}}$$

Herein, r_{diag(2)} may represent the second diagonal driving ratio, r_{str 2} may represent the second turning driving ratio, aβₐ and bβ_{ww} may represent second normalization constants, a_{y} may represent the lateral acceleration, vω may represent the centripetal acceleration, kₐ and k_{vω} may represent normalization ratios of the lateral acceleration and the centripetal acceleration, vₘₐₓ may represent a maximum driving velocity of the mobility, and v may represent an initial driving velocity of the mobility.

In addition, aβₐ may correspond to a left side of a β region and may be associated with a turning driving region. That is, as the driving velocity decreases, the turning driving region may be secured rather than the diagonal driving region, allowing a turning radius to be reduced.

In other words, as the centripetal acceleration becomes larger compared to the lateral acceleration in an embodiment, a second turning driving ratio 622 may increase, resulting in a larger turning driving angle.

In addition, bβ_{vw} may correspond to a right side of a β region and may be associated with a diagonal driving region. That is, as the driving velocity increases, the diagonal driving region may be secured rather than the turning driving region, promoting stability in driving control.

In other words, as the lateral acceleration becomes larger compared to the centripetal acceleration in an embodiment, a second diagonal driving ratio 621 may increase, resulting in a larger diagonal driving angle.

Meanwhile, referring to FIG. 6, it can be confirmed that the second driving ratio has a dependent relationship with respect to the first driving ratio and is less than or equal to the first driving ratio.

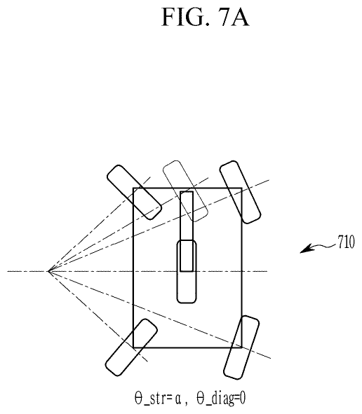

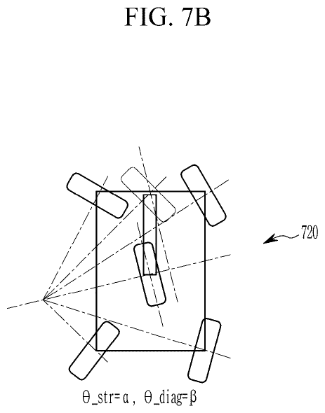

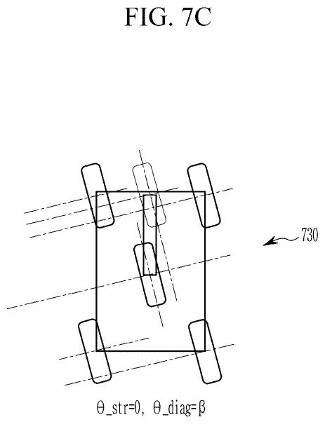

FIG. 7 illustrates an example of driving control of a mobility by referring to a model diagonal driving angle and a model turning driving angle according to an embodiment.

Referring to FIG. 7, the mobility driving control apparatus 100 may control driving of the mobility to move to the target position by referring to the steering angle corresponding to each of at least one steering eccentric drive wheel. determined using a steering model.

Referring to FIG. 7A, based on the model diagonal driving angle being 0, the mobility driving control apparatus 100 may control the turning driving of the mobility by referring to a steering angle of each of at least one steering eccentric drive wheel, which is determined based on the model turning driving angle α.

Referring to FIG. 7B, based on the model turning angle and the model diagonal angle not being 0, the mobility driving control apparatus 100 may control driving of the mobility by referring to the steering angle of each of at least one steering eccentric drive wheel, which is determined based on the model turning driving angle α and the model diagonal driving angle β.

Referring to FIG. 7C, based on the model turning angle being 0, the mobility driving control apparatus 100 may control the driving of the mobility by referring to a steering angle of each of at least one steering eccentric drive wheel, which is determined based on the model diagonal driving angle β.

Combinations of each block in the block diagrams and each operation in the flowcharts attached to the present disclosure may also be executed by computer program instructions. These computer program instructions may be embedded in an encoding processor of a general-purpose computer, a special-purpose computer, or other programmable data processing apparatus, and thus the instructions, when executed by the encoding processor of the computer or other programmable data processing apparatus, may create a means for performing the functions described in each block of the block diagram or each operation of the flowchart. These computer program instructions may also be stored in a computer-available or computer-readable memory capable of directing a computer or other programmable data processing apparatus to implement functions in a particular manner, so the instructions stored in the computer-available or computer-readable memory may also produce an article of manufacture that includes instruction means for performing the functions described in each block of the block diagram or each operation of the flowchart. The computer program instructions may also be installed on a computer or other programmable data processing apparatus, a series of operations may be performed on the computer or other programmable data processing apparatus to create a computer-executable process, and the instructions that cause the computer or other programmable data processing apparatus to perform the operations for executing the functions described in each block of the block diagram and each operation of the flowchart may also provide operations for executing the functions described in each block of the block diagram and each operation of the flowchart.

Additionally, each block or each operation may represent a module, segment or portion of code that contains one or more executable instructions for executing a particular logical function(s). It should also be noted that in some alternative embodiments, the functions mentioned in the blocks or operations may occur out of order. For example, two blocks or operations shown in succession may in fact be performed substantially simultaneously, or the blocks or operations may sometimes be performed in reverse order, depending on the functionality they serve.

The above description is merely illustrative of the technical idea of the present disclosure, and those skilled in the art to which the present disclosure pertains may make various modifications and variations without departing from the essential characteristics of the present disclosure. Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A method for controlling a mobility, the method comprising:
determining position error information of the mobility based on a current position and a target position of the mobility;
determining a diagonal driving angle and a turning driving angle of the mobility based on the position error information;
determining a steering angle corresponding to each of at least one steering eccentric drive wheel of the mobility based on the diagonal driving angle and the turning driving angle of the mobility; and
controlling the mobility to move to the target position based on the steering angle corresponding to each of the at least one steering eccentric drive wheel.

2. The method of claim 1, wherein determining the position error information of the mobility comprises determining a rotational angle error, a lateral position error, and a longitudinal position error of the mobility based on the current position and the target position using an error model.

3. The method of claim 1, wherein determining the diagonal driving angle and the turning driving angle of the mobility comprises:
determining a first driving ratio based on a static importance corresponding to diagonal driving and turning driving of the mobility from the position error information,
determining a second driving ratio based on dynamic importance corresponding to diagonal driving and turning driving of the mobility based on an initial driving information of the mobility determined according to the first driving ratio, and
determining a diagonal driving angle and a turning driving angle of the mobility based on the second driving ratio.

4. The method of claim 3, wherein determining the first driving ratio based on the static importance comprises determining a first diagonal driving ratio and a first turning driving ratio of the mobility based on a ratio between a rotational angle error and a lateral position error of the mobility.

5. The method of claim 3, wherein determining the second driving ratio based on dynamic importance comprises determining a second diagonal driving ratio and a second turning driving ratio of the mobility based on a ratio of lateral acceleration and centripetal acceleration of the mobility.

6. The method of claim 5, wherein the second diagonal driving ratio and the second turning driving ratio are determined based on determining a ratio of a maximum driving velocity and an initial driving velocity of the mobility.

7. The method of claim 3, wherein determining the diagonal driving angle and the turning driving angle of the mobility comprises:
determining the diagonal driving angle of the mobility based on a maximum lateral velocity determined based on a lateral error of the mobility and a second diagonal driving ratio, and
determining the turning driving angle based on a maximum rotational velocity determined based on a rotational angle error of the mobility and a second turning driving ratio.

8. The method of claim 1, wherein determining the steering angle corresponding to each of the at least one steering eccentric drive wheel comprises determining a first wheel having a minimum steering drive range based on an eccentric position corresponding to each of the at least one steering eccentric drive wheel.

9. The method of claim 8, wherein determining the steering angle corresponding to each of the at least one steering eccentric drive wheel comprises:
determining a model turning driving angle corresponding to a steering model of the mobility based on the turning driving angle within a range of a maximum steering angle of the first wheel, and
determining a model diagonal driving angle corresponding to the steering model based on the diagonal driving angle within an angle range excluding the model turning driving angle in the maximum steering angle of the first wheel.

10. The method of claim 9, wherein determining of the steering angle corresponding to each of the at least one steering eccentric drive wheel comprises determining the steering angle corresponding to each of the at least one steering eccentric drive wheel based on the model turning driving angle and the model diagonal driving angle.

11. An apparatus for controlling a mobility, the apparatus comprising:
at least a processor; and
a memory configured to store instructions for a mobility driving control program, the instructions, when executed by the processor, cause the processor to:
determine position error information of the mobility based on a current position and a target position of the mobility;
determine a diagonal driving angle and a turning driving angle of the mobility based on the position error information;
determine a steering angle corresponding to each of at least one steering eccentric drive wheel of the mobility based on the diagonal driving angle and the turning driving angle of the mobility; and
control the mobility to move to the target position based on the steering angle corresponding to each of the at least one steering eccentric drive wheel.

12. The apparatus of claim 11, wherein the instructions further cause the processor to determine a rotational angle error, a lateral position error, and a longitudinal position error of the mobility based on the current position and the target position using an error model.

13. The apparatus of claim 11, wherein the instructions further cause the processor to:
determine a first driving ratio based on static importance corresponding to diagonal driving and turning driving of the mobility from the position error information,
determine a second driving ratio based on dynamic importance corresponding to diagonal driving and turning driving of the mobility based on initial driving information of the mobility determined according to the first driving ratio; and
determine the diagonal driving angle and the turning driving angle of the mobility based on the second driving ratio.

14. The apparatus of claim 13, wherein the instructions further cause the processor to determine a first diagonal driving ratio and a first turning driving ratio of the mobility based on a ratio between a rotational angle error and a lateral position error of the mobility.

15. The apparatus of claim 13, wherein the instructions further cause the processor to determine a second diagonal driving ratio and a second turning driving ratio of the mobility based on a ratio of lateral acceleration and centripetal acceleration of the mobility.

16. The apparatus of claim 13, wherein the instructions further cause the processor to:
determine the diagonal driving angle of the mobility based on a maximum lateral velocity determined based on a lateral error of the mobility and a second diagonal driving ratio; and
determine the turning driving angle based on a maximum rotational velocity determined based on a rotational angle error of the mobility and a second turning driving ratio.

17. The apparatus of claim 11, wherein the instructions further cause the processor to determine a first wheel having a minimum steering drive range based on an eccentric position corresponding to each of the at least one steering eccentric drive wheel.

18. The apparatus of claim 17, wherein the instructions further cause the processor to:
determine a model turning driving angle corresponding to a steering model of the mobility based on the turning driving angle within a range of a maximum steering angle of the first wheel; and
determine a model diagonal driving angle corresponding to the steering model based on the diagonal driving angle within an angle range excluding the model turning driving angle in the maximum steering angle of the first wheel.

19. The apparatus of claim 18, wherein the instructions further cause the processor to determine the steering angle corresponding to each of the at least one steering eccentric drive wheel based on the model turning driving angle and the model diagonal driving angle.

20. A non-transitory computer-readable medium storing instructions for controlling a mobility, the instructions, when executed by a processor, cause the processor to perform:
determining position error information of the mobility based on a current position and a target position of the mobility;
determining a diagonal driving angle and a turning driving angle of the mobility based on the position error information;
determining a steering angle corresponding to each of at least one steering eccentric drive wheel of the mobility based on the diagonal driving angle and the turning driving angle of the mobility; and
controlling driving of the mobility to move to the target position based on the steering angle corresponding to each of the at least one steering eccentric drive wheel.
